(19) United States
(12) Patent Application Publication
(10) Pub. No.: US 2020/0292902 A1
(43) Pub. Date: Sep. 17, 2020

(54) PROCESS AND APPARATUS FOR SWITCHING REDOXACTIVE CELLS

(71) Applicant: BASF SE, Ludwigshafen am Rhein (DE)

(72) Inventors: Daniel Waldmann, Lambsheim (DE); Jens Roeder, Mannheim (DE); Michael Goebel, Neustadt (Weinstr.) (DE); Maraike Ahlf, Schriesheim (DE)

(21) Appl. No.: 16/082,013

(22) PCT Filed: Mar. 7, 2017
(86) PCT No.: PCT/EP2017/055316

§ 371 Date: Sep. 4, 2018

(30) Foreign Application Priority Data
Mar. 7, 2016 (EP) 16159021.1

(51) Int. Cl. G02F 1/155; G02F 1/153; G02F 1/1516; G02F 1/163

(52) U.S. Cl. CPC G02F 1/155; G02F 1/1533; G02F 2202/36; G02F 1/163; G02F 1/15165

(57) ABSTRACT

Described herein is a process for switching an electrochromic cell including at least a first electrode layer and a second electrode layer. The cell also includes an ion-conducting layer that separates the first and second electrode layers and a temperature sensor for measuring a temperature in or on or in the vicinity of the electrochromic cell. Moreover, a first contact member is electronically connected with the first electrode layer, and a second contact member is electronically connected with the second electrode layer. Furthermore, at least the first electrode layer includes an organic polymer matrix and, dispersed therein, an electrochromic material, electronically conductive nanoobjects, and an electrolyte dissolved in a solvent. Further, the process including measuring the current flowing through the cell if a voltage is applied to the electrode layers, applying a voltage to the contact members, and varying the applied voltage as a function of the current.

The present invention relates to a process, an apparatus and a system for switching electrochromic cells, wherein the voltages are controlled in order not to overstress the cells.

Electrochromic cells comprise electrochromic material which changes its optical properties when ions and electrons are inserted into it under the influence of an electric field caused by a voltage applied. In particular, the electrochromic material can be switched between a coloured and a decoloured state.

For example, electrochromic cells are used as switchable glazing or windows to prevent a room or an area which is equipped with such glazing from heating-up by sunlight. In particular, an energy management of a whole building can be influenced by windows comprising electrochromic cells.

For using electrochromic cells in windows, the electrochromic material is imbedded as a lamination layer in laminated glass of the window. Therefore, the requirements regarding the lifetime of the materials are very stringent. Preferably, a lifetime is desired that is comparable to conventional windows.

However, lifetime of electrochromic cells depend on the magnitude of the applied voltages and on the amount of charge inserted into the electrochromic layers of the electrochromic cell. The range of voltages which may be applied between the electrode layers for switching, without causing device degradation is often referred to as the redox stability range. The redox stability range is defined as the range between a positive and a negative redox voltage limit.

Consequently, voltage and charge limits have to be considered. Thus, voltage and charge limits have to be determined by experimentation. The redox stability range may be determined, for example, by cyclic voltammetry experiments at various temperatures.

The applied voltage may then be limited accordingly, thereby ensuring that the maximum voltage between the electrode layers does not exceed the limits of the redox stability range for that particular system. However, the consequence of simple limiting the voltage will lead to very low currents in different states of the switching process which reduces the switching speed significantly.

Further, switching with high currents allows higher switching speed or lower switching times but results in higher inhomogeneity of colouration or decolouration of the electrochromic material. The reason for the inhomogeneity is that the distribution of electrical voltages between the electrode layers of a cell depends inherently on the resistance of the electrode layers and the cell current.

High currents cause a greater internal voltage drop across the electrode layers which results in a less homogeneous voltage distribution.

Consequently, the object of the invention is to find a method for switching an electrochromic cell, wherein it has to be ensured that the potential between the electrode layers is always between safe redox limits. Further, it is an object of the invention to limit the cell current for optimisation of switching speed and transmission homogeneity.

The present invention solves the problems identified in the prior art as described above.

Therefore, the invention comprises a process and an apparatus for switching an electrochromic cell. The electrochromic cell comprises at least a first electrode layer and a second electrode layer each capable of reversibly inserting ions. Further, the cell comprises an ion-conducting layer that separates the first electrode layer and the second electrode layer.

Moreover, a temperature sensor is comprised for measuring a temperature in or on or in the vicinity of the electrochromic cell.

Further, a first contact member is electronically connected with the first electrode layer and a second contact member is electronically connected with the second electrode layer. The first and the second electrode layer are counter electrodes to each other.

Furthermore, the at least said first electrode layer comprises an organic polymer matrix and, an electrochromic material, electronically conductive nanoobjects and an electrolyte dissolved in a solvent are dispersed within said organic polymer matrix.

For switching the electrochromic cell, the invention comprises the step of measuring the current i_{C} flowing through the cell if a voltage is applied to the electrode layers. Consequently, a voltage U_{C} is applied to the contact members and varied as a function of current. The voltage U_{C} is preferably set by a controller. Thereby, the voltage generated between the electrode layers is kept within predetermined temperature dependent safe redox limits U_{EC} and such that the cell current is kept within predetermined temperature-dependent limits.

In particular, the applied voltage U_{C} is only increased if the cell current i_{C} is less than a maximum cell current, determined according to:

iₘₐₓ=jₘₐₓ×Area+(T−T₀)×F

In the above equation, jₘₐₓ is a predetermined maximum current density, Area is the active cell area, T is the temperature of the electrochromic cell measured with the temperature sensor, and T₀ is a reference temperature. However, the factor F allows the modification of the current according to temperature. Thereby, the factor F allows the modification of switching speed with respect to temperature.

As it is not possible to measure the voltage between the electrode layers directly, because the two electrode contacts are on opposite sides of the cell, it is only possible to directly measure the applied contact voltage U_{C} and estimate the voltage between the electrode layers.

However, the voltage between the electrode layers varies significantly over the area of the cell depending on the distance from the two electrode contacts. In particular, the largest potential difference between electrode layers always occurs at the edges of the cell, adjacent to the electrode contacts. Therefore, it is not necessary to know the complete voltage distribution of the cell under a given set of conditions.

It was found that the relationship between the applied contact voltage and the maximum voltage generated between the electrode layers may be described by a simple equation, involving cell current and a constant resistance of the cell, wherein the resistance is only dependent on cell width and height and on material properties of the electrode layer.

The resistance may then be calculated from w and h which are cell width and height in centimetres. The height corresponds to the length of the contacted cell edges. Further, a factor k which is a constant representative of the material used for the electrode layer in electrochromic devices has to be considered. Consequently, the resistance is calculated as follows:

R_{Eff}=(w/h)×k

Further, the maximum voltage generated between the electrode layers U_{f,max} occurring at the cell edges adjacent to the electrode contacts can be calculated using the formula:

U_{f,max}=U_{C}−i_{c}R_{Eff}

where U_{C} is the potential applied to the cell contacts, i_{C} is the cell current and R_{Eff} is the effective resistance of the cell. Further, a safe redox limit U_{EC} is predetermined for a given switching process from electrochemical studies. Consequently, the applied contact voltage can be limited appropriately using the following calculation:

U_{C,max}=U_{EC}+i_{C}R_{Eff}

If the voltage applied at the cell contacts U_{C} is maintained below the maximum limit U_{C,max}, then it is indirectly ensured that the maximum voltage between the electrode layers U_{f,max} does not exceed its corresponding safe redox limit U_{EC}.

Consequently, it was found that if the applied voltage U_{C} is only increased if the cell current i_{C} is less than a maximum cell current, determined according to:

iₘₐₓ=jₘₐₓ×Area+(T−T₀)×F

the maximum voltage between electrode layers U_{C,max} does not exceed the temperature-dependent safe electrochemical limit U_{EC}, wherein a voltage U_{C} is applied which is always as high as possible to ensure the maximum possible switching speed.

It has to be noted that the invention is described with respect to switching an electrochromic cell comprising the cases of colouration and decolouration of the cell. Consequently, the applied voltage U_{C} and the current i_{C} flowing through the cell as well as the other values can be distinguished as positive during colouration and negative during decolouration or vice versa depending on the polarity of the devices for measurement.

Consequently, to avoid confusion in the description of this invention, the values, for example the voltage U_{C} and the current i_{C}, are considered as positive values, only. These values are representative of one of the different switching case.

Accordingly, the safe redox range characterized by the safe redox limits, namely a positive and a negative safe redox limit, will be considered with respect to the maximum value of the safe redox limit, namely the positive safe redox limit.

According to a first embodiment of the invention, the current flowing through the cell is measured in a non-continuous way. However, switching a window with an electrochromic cell will take several minutes. Therefore, the current will not significantly change in short intervals, like millisecond. Therefore, measuring the current in a non-continuous fashion, namely in time intervals, can be easy handled by a relatively cheap controller or microcontroller with a slow clock frequency without running the risk to exceed the save redox limits.

According to a further embodiment, the applied voltage is increased in a linear fashion if the cell current is less than the maximum cell current and the voltage generated between the electrode layers is within predetermined temperature dependent safe redox limits.

Thus, no stepwise change in the voltage occurs. A stepwise voltage change would however result in current peaks as it was found that this special electrochromic cell will behave as a capacitor for fast switching. Consequently, a stepwise change of the voltage can result in high current peaks which can reduce the lifetime of the cell significantly. However, increasing the voltage in a linear fashion will reduce the risk of high current peaks.

According to a further embodiment, the current flowing through the cell is measured over the time for calculating the charge inserted into the electrode layers. Therefore, the amount of charge inserted into the electrochromic cell can be calculated easily to switch of the voltage in the case the cell is switched in predetermined fashion or reaches a predetermined stage.

For example, if the cell should not be coloured or decoloured completely, the value for the amount of charge for the desired stage can be deposit in a memory. If the value is reached, the voltage can be switched off.

Further, for switching the cell completely, namely in a fully coloured or decoloured stage, the voltage can be switched off at the right time to ensure not to overcharge the cell. Therefore, an overcharge of the cell leading to the risk of reduced cycle time can be prevented.

According to a further embodiment, the applied voltage is increased or decreased depending on a further input of the controller, wherein the controller preferably has a loop-controller or a PID controller. The output of the controller therefore gives the value for the voltage. On the other hand, the controller has an input to measure the voltage at the contact members and increases or decreases the output so that the substantially exact voltage is applied to the contacts. Thus, the risk of voltages which pass over the safe redox limits will be eliminated.

According to a further embodiment, the leakage current of the cell is determined. The leakage current is defined as the current due to electrons flowing between the electrodes arising from the non-perfect electrical insulating behavior of the electrolyte layer. The leakage current is preferably measured in the fully colored or fully decoloured state by applying a constant DC voltage smaller than the voltage used for coloration/decoloration. The resulting current is measured over time and the value to that the current is converging is an estimation for the leakage current. To determine the leakage current is necessary to calculate the charge that is inserted into the electrochromic layers correctly. Only measuring the current leads to an overestimation of the inserted charge as the measured current is the sum of current due to ion movement and the leakage current.

Further, the invention comprises an apparatus for switching an electrochromic cell. The apparatus comprises at least a first and a second electrode layer which are each capable of reversibly inserting ions. The layers are separated by an ion-conducting layer. Further, the apparatus comprises a temperature sensor for measuring a temperature in or on or in close vicinity of the electrochromic cell.

Moreover, the apparatus comprises a first contact member which is electronically connected with the first electrode layer and a second contact member which is electronically connected with the second electrode layer. The first and the second electrode layer are counter electrodes to each other.

Furthermore, at least said first electrode layer comprises an organic polymer matrix and dispersed within said organic polymer matrix an electrochromic material, electronically conductive nanoobjects and an electrolyte dissolved in a solvent.

Further, the apparatus comprises means for applying a voltage to the contact members and a controller connected to the means for applying a voltage. In addition, the apparatus comprises an ammeter, adapted to measure the cell current and to send the measured values of the cell current to the controller. The controller is adapted to calculate the magnitude of the electrical voltage to be applied to the cell contact members based on values of temperature, electrochromic voltage limits and cell current.

Further, the controller is adapted to increase the applied voltage as a function of current, such that the voltage generated between the electrode layers is kept within predetermined temperature-dependent safe redox limits and such that the cell current is kept between predetermined temperature-dependent limits.

The controller is adapted to increase the applied voltage only if the cell current is less than a maximum cell current determined according to equation as already discussed in relation to the inventive process, namely:

iₘₐₓ=jₘₐₓ×Area+(T−T₀)×F.

According to an embodiment of the apparatus, the ammeter is adapted to measure the current flowing through the cell in a non-continuous way. Further, according to another embodiment the controller is adapted to increase the applied voltage in a linear fashion, if the cell current is less than the maximum cell current and the voltage generated between the electrode layers is within predetermined temperature dependent safe redox limits.

In another embodiment of the apparatus, the ammeter is adapted to measure the current flowing through the cell over the time for calculating the charge inserted into the electrode layers. According to a further embodiment, the apparatus comprises a loop-controller or a PID controller, adapted to increase or decrease the applied voltage depending on the measured voltage at the contact members. Further, according to another embodiment, the controller is adapted to determine the leakage current of the cell.

According to an embodiment of the apparatus, the electrochromic material is present in the form of nanoobjects, preferably nanoparticles.

Providing the electrochromic material in the form of nanoobjects, preferably nanoparticles, allows for uniform distribution and secure immobilization of the electrochromic material within the organic polymer matrix of the electrode layer. Furthermore, electrochromic material in the form of nanoobjects, preferably nanoparticles, readily interacts with an electronically conductive network formed of electronically conductive nanoobjects, preferably nanowires, thus allowing uniform electronic contact to the electrochromic material throughout the electrode layer, and due to the small dimensions of the nanoobjects of the electrochromic layer, electrons do not need to travel over large distances in regions exhibiting low electronic conductivity.

According to a preferred embodiment of the apparatus, the electronically conductive nanoobjects are nanowires, preferably silver nanowires.

Electronically conductive nanowires are capable of imparting appropriate electronic conductivity to the electrode layer by forming an interconnected network at low concentration. Since their diameter is in the nanoscale (below 50 nm, preferably between 20 nm and 35 nm), nanowires are not visible or substantially not visible and do not distract from any visual appearance of the device.

According to a further embodiment, said first electrode layer is disposed on a first optically transparent electronically conductive layer, and said first contact member contacts said first optically transparent electronically conductive layer. Moreover, said second electrode layer is disposed on a second optically transparent electronically conductive layer, and said second contact member contacts said second optically transparent electronically conductive layer. Furthermore, said first optically transparent electronically conductive layer is disposed on a first electrically insulating optically transparent substrate and said second optically transparent electronically conductive layer is disposed on a second electrically insulating optically transparent substrate. Further, said first electrically insulating optically transparent substrate and/or second electrically insulating optically transparent substrate is glass or organic polymer.

Disposing the electrode layers on optically transparent layers which are electronically conductive enables uniform current distribution over the whole area of the electrode, thus ensuring uniform and fast colour change or the electrochromic material in the electrode layer.

According to a further embodiment, said first electrode layer is disposed on a first electrically insulating optically transparent substrate, and said first contact member contacts the edge of said first electrode layer. Moreover, said first electrically insulating optically transparent substrate is glass or organic polymer. Further, said second electrode layer is disposed on an optically transparent electronically conductive layer, and said second contact member contacts said optically transparent electronically conductive layer. Finally, said optically transparent electronically conductive layer is disposed on a second electrically insulating optically transparent substrate and said second electrically insulating optically transparent substrate is glass or organic polymer.

In another embodiment, said first electrode layer is disposed on an electrically insulating optically transparent substrate, and said first contact member contacts the edge of said first electrode layer. Further, said first electrically insulating optically transparent substrate is glass or organic polymer. Said second electrode layer comprises an organic polymer matrix and dispersed within said organic polymer matrix an electrochromic material, electronically conductive nanoobjects and an electrolyte dissolved in a solvent.

Moreover, said second electrode layer is disposed on an electrically insulating optically transparent substrate, and said second contact member contacts the edge of said second electrode layer. Finally, said second electrically insulating optically transparent substrate is glass or organic polymer.

If the electronic in-plane conductivity of the first electrode layer or of both electrode layers is sufficiently high, there is no need to provide optically transparent electronically conductive layer(s) for contacting said electrode layer(s), and the electrode layer(s) can be disposed directly on the electrically insulating optically transparent substrate(s). Doing so reduces complexity of the device, facilitates manufacturing thereof and reduces costs. Appropriate high in-plane conductivity of the electrode layer may be achieved by means of incorporating electronically conductive nanowires into the electrode layer.

Further, the invention comprises a system for switching at least one electrochromic cell comprising a master unit and at least one apparatus comprising an electrochromic cell and a controller according to any of the prior embodiments of the apparatus.

The master unit is coupled to the at least one apparatus and is adapted to supply a trigger signal to the controller of the at least one apparatus, wherein the controller of the at least one apparatus is adapted to switch the electrochromic cell of the at least one apparatus in response the trigger signal.

Consequently, the system can be integrated in a building, wherein the master controller can generate the trigger depending on the sun light irradiating on the building. Then the controller of the apparatus switches the cell and taking into account the parameters to ensure a fast switching while the safe redox limits are considered.

According to a further embodiment of the system, the controller of the at least one apparatus is adapted to store at least one of the measured parameters of the at least one apparatus. Therefore, the master unit can load the stored parameters, i.e. the temperature measured with the temperature sensor, to use this parameters for deciding if a trigger is send or not.

According to a further embodiment of the system, the controller of the at least one apparatus is in bidirectional communication with said master unit. A communication in both directions between the controller and the master unit ensures that the master unit can monitor the parameters and the stage of the controller on the one hand and on the other hand to send—beside the mentioned trigger—further instructions to control the colouration or decolouration, i.e. the stage of colouration or decolouration.

According to a further embodiment of the system, the master unit is adapted to monitor the stored parameter of the at least one apparatus and to generate the trigger depending on the monitored parameter. Thus, there is no need for extra sensors connected to the master unit, because the master unit can use the integrated temperature sensors of the apparatuses to decide if a trigger needs to be generated.

Further features and advantages of the invention arise from the following description of preferred embodiments, wherein reference is made to the drawings:

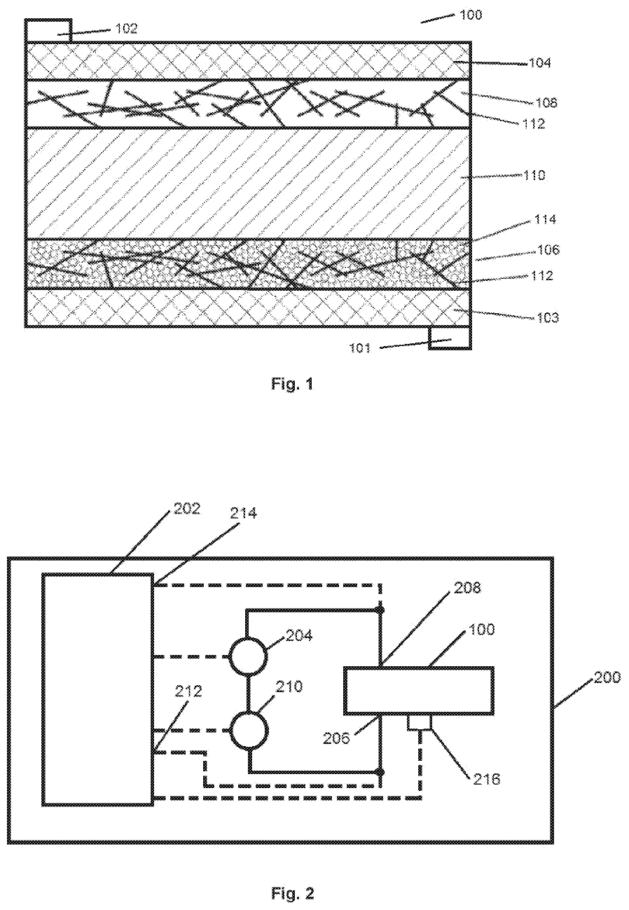

FIG. 1 shows an embodiment of an electrochromic cell;

FIG. 2 an embodiment of the apparatus and

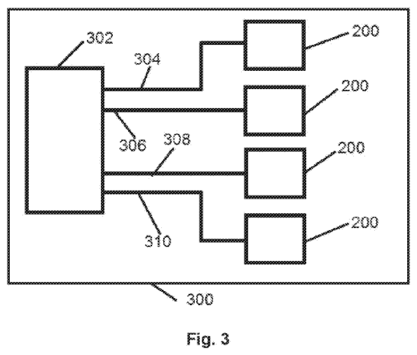

FIG. 3 an embodiment of the system.

FIG. 1 shows an electrochromic cell 100 which comprises a first contact member 101 and a second contact member 102. Two conductive layers 103, 104 are connected with the first 101 and second contact member 102, respectively. At least one of these conductive layers 103, 104 is transparent. Further, a first electrode layer 106 and a second electrode layer 108 are shown which are separated with an ion-conducting layer 110.

The electrode layers 106, 108 comprise an electrochromic material and electronically conductive nanowires 112. These nanowires form an interconnected mesh throughout each of the electrode layers 106, 108 and also touch the conductive layers 103, 104. Thus, these wires impart electronic conductivity throughout the organic polymer matrix of the respective electrode layer and improve the performance efficiency of the electrode. At least the first electrode layer 106 comprises an electrolyte 114 dissolved in a solvent.

Since nanowires are thin, these are still optically transparent. Further, the electrochromic particles in electrode 106 may be large particles or nanoparticles and may be of any shape. These particles may be rod like, spherical, disc like cubes, etc. It is not necessary that conductive nanowires 112 are used for both electrode layers 106, 108, as an example if the electrolyte is opaque for a display use, and all the visual change is coming from layer 106 as one looks through the first conductive layers 103, then one can use a carbon based counterelectrode as layer 108 which may have sufficient electronic conductivity.

Preferably, a first support layer is attached to the surface of the first substrate facing away from the first electrode layer and a second support layer is attached to the surface of the second substrate facing away from the second electrode layer. In this regard, it is particularly preferred that the first and second substrate comprise materials from the group of organic polymers and are in the form of foils, films, webs, and the first and second support layer comprise glass.

Furthermore, it is preferred that a third support layer is attached to the surface of the first support layer facing away from the first substrate and/or a fourth support layer is attached to the surface of the second support layer facing away from the second substrate. In this regard, it is particularly preferred that a third support layer is attached to the surface of the first support layer facing away from the first substrate and a fourth support layer is attached to the surface of the second support layer facing away from the second substrate. In this regard, it is particularly preferred that the first, second, third and fourth support layer comprise glass.

FIG. 2 shows a simplified block diagram of the apparatus 200 with the electrochromic cell 100. A controller 202 controls a voltage source 204 to apply the voltage U_{C} to the contact members 206, 208 of the electrochromic cell 100. In parallel, the controller measures the current i_{C} with an ammeter 210 and the voltage applied to the contacts 206, 208 with inputs 212, 214 of the controller 202.

The controller 202 has a memory and is pre-programmed with the values for the effective resistance of the cell R_{Eff} and the maximum redox safe voltage U_{EC}. Thus, the controller 202 calculates the maximum voltage U_{C,max} as follows:

U_{C,max}=U_{EC}+i_{C}R_{Eff}

This voltage U_{C,max} is the maximum value which the controller 202 controls the voltage source 204 to apply to the contacts 206, 208. Moreover, the maximum cell current iₘₐₓ is calculated as follows:

iₘₐₓ=jₘₐₓ×Area+(T−T₀)×F

Further, the controller 202 is pre-programmed with the Area, in particular 100 cm×50 cm of the cell and a factor F, in example F is 1, for the desired switching speed. Moreover, jₘₐₓ is calculated as the maximum charge density for colouration divided by the desired time for a complete switching from a decoloured to a coloured state of the cell 100.

Further, when the process of switching is initiated, the temperature T of the cell is measured with a temperature sensor 216 and a starting voltage, in example of 5% of U_{C,max}, is applied to the contacts 206, 208. Moreover, beginning from this starting voltage, the applied voltage U_{C} is increased if the measured cell current i_{C} is less than the maximum cell current iₘₐₓ.

Furthermore, the controller monitors the current i_{C} over time and calculates the charge of the cell 100. If a desired amount of charge is reached and therefore, the cell 100 has a desired stage of colouration, the voltage U_{C} is switched off.

FIG. 3 shows a system 300 with four apparatuses 200. The system 300 comprises a master unit 302 which is connected to the controllers 202 (see FIG. 2) of the apparatuses 200 by data links 304, 306, 308, 310. The master unit 302 requests the temperature T of each of the temperature sensors 216 of the apparatuses 200, preferably in intervals of seconds or minutes.

In the case any of the apparatuses 200 transfers a temperature value which is above a first predetermined values, in example 35° C., the master unit 302 sends a trigger to the controller 202 of the respective apparatus 200 which has transferred the temperature value above the predetermined value. Preferably, the master unit 302 sends one or more further triggers to the controllers 202 of one or more apparatuses 200 which are associated with the apparatus 200 which has transferred the temperature value above the predetermined value. Each trigger then causes the controller 202 of the respective apparatus 200 to switch the cell 100 of the respective apparatus 200 according to an embodiment of the inventive process.

List of reference numbers

| | |
|---|---|
| 100 | Electrochromic cell |
| 101 | First contact member |
| 102 | Second contact member |
| 103 | First transparent |
| | layer |
| 104 | Second transparent |
| | layer |
| 106 | First electrode layer |
| 108 | Second electrode layer |
| 110 | Ion-conducting layer |
| 112 | Electronically |
| | conductive nanowires |
| 114 | Electrolyte |
| 200 | Apparatus |
| 202 | Controller |
| 204 | Voltage source |
| 206, 208 | Contact memberss of the |
| | electrochromic cell |
| 210 | Ammeter |
| 212, 214 | Inputs |
| 216 | Temperature sensor |
| 300 | System |
| 302 | Master unit |
| 304, 306, | Data links |
| 308, 310 | |
| i_{C} | Cell current |
| iₘₐₓ | Maximum cell current |
| F | Factor |
| R_{Eff} | Cell |
| T | Temperature |
| U_{C} | Voltage |
| jₘₐₓ | Predetermined |
| | maximum current density |
| Area | Active cell area |
| T₀ | Reference temperature |
| U_{C, max} | Maximum voltage |
| UEC | Maximum redox safe |
| | voltage |

1. Process for switching an electrochromic cell comprising the following components:
a first electrode layer capable of reversibly inserting ions,
a second electrode layer capable of reversibly inserting ions,
an ion-conducting layer that separates the first electrode layer and the second electrode layer,
a temperature sensor for measuring a temperature (T) in or on or in the vicinity of the electrochromic cell,
a first contact member electronically connected with the first electrode layer,
a second contact member electronically connected with the second electrode layer,
wherein the first and the second electrode layer are counter electrodes to each other, and wherein at least the first electrode layer comprises:
an organic polymer matrix, and
dispersed within the organic polymer matrix:
an electrochromic material,
electronically conductive nanoobjects, and
an electrolyte dissolved in a solvent,
wherein the process comprises the steps of:
applying a voltage (U_{C}) to the first and second contact members and measuring a current (i_{C}) flowing through the electrochromic cell if the voltage is applied; and
varying the applied voltage (U_{C}) as a function of the cell current (i_{C}), such that the voltage generated between the first and second electrode layers is kept within predetermined temperature (T) dependent safe redox limits and such that the cell current (i_{C}) is kept within predetermined temperature-dependent limits,
wherein
the applied voltage (U_{C}) is only increased if the cell current (i_{C}) is less than a maximum cell current (iₘₐₓ), determined according to:
iₘₐₓ=jₘₐₓ×Area+(T−T₀)×F,
where jₘₐₓ is a predetermined maximum current density, Area is the active cell area, T is the temperature of the electrochromic cell measured with the temperature sensor, T₀ is a reference temperature, and F is a factor.

2. Process according to claim 1, wherein the current (i_{C}) flowing through the electrochromic cell is measured in a non-continuous way.

3. Process according to claim 1, wherein the applied voltage (U_{C}) is increased in a linear fashion if the cell current (i_{C}) is less than the maximum cell current (iₘₐₓ) and the voltage (U_{C}) generated between the first and second electrode layers is within predetermined temperature (T) dependent safe redox limits.

4. Process according to claim 1, wherein the current (i_{C}) flowing through the cell is measured over the time for calculating the charge inserted into the first and second electrode layers.

5. Process according to claim 1, wherein the applied voltage (U_{C}) is increased or decreased by a controller depending on measured voltage (U_{C}) of the first and second contact members.

6. Process according to claim 1, further comprising a step of determining a leakage current of the electrochromic cell.

7. Apparatus for switching an electrochromic cell, wherein the apparatus comprises the following components:
a first electrode layer capable of reversibly inserting ions,
a second electrode layer capable of reversibly inserting ions,
an ion-conducting layer that separates the first electrode layer and the second electrode layer,
a temperature sensor for measuring a temperature (T) in or on or in close vicinity of the electrochromic cell,
a first contact member electronically connected with the first electrode layer,
a second contact member electronically connected with the second electrode layer,
wherein the first and the second electrode layer are counter electrodes to each other, and wherein at least the first electrode layer comprises:
an organic polymer matrix, and
dispersed within the organic polymer matrix:
an electrochromic material,
electronically conductive nanoobjects, and
an electrolyte dissolved in a solvent,
wherein the apparatus further comprises:
means for applying a voltage (U_{C}) to the first and second contact members;
a controller connected to the means for applying the voltage (U_{C});
an ammeter, adapted to measure a cell current (i_{C}) and to send the measured values of the cell current (i_{C}) to the controller, wherein the controller is adapted to calculate a magnitude of the electrical voltage (U_{C}) to be applied to the first and second contact members based on values of the measured temperature (T), electrochromic voltage limits, and the cell current (i_{C}), wherein the controller is further adapted to increase the applied voltage (U_{C}) as a function of the cell current (i_{C}), such that the voltage generated between the first and second electrode layers is kept within predetermined temperature-dependent safe redox limits and such that the cell current (i_{C}) is kept within predetermined temperature-dependent limits,
wherein
the controller is further adapted to increase the applied voltage (U_{C}) only if the cell current (i_{C}) is less than a maximum cell current (iₘₐₓ) determined according to
iₘₐₓ=jₘₐₓ×Area+(T−T₀)×F,
where jₘₐₓ is a predetermined maximum current density, Area is the active cell area, T is the temperature of the electrochromic cell measured with the temperature sensor, T₀ is a reference temperature, and F is a factor.

8. Apparatus according to claim 7, wherein the ammeter is adapted to measure the current (i_{C}) flowing through the electrochromic cell in a non-continuous way.

9. Apparatus according to claim 7, wherein the controller is further adapted to increase the applied voltage (U_{C}) in a linear fashion, if the cell current (i_{C}) is less than the maximum cell current (iₘₐₓ) and the voltage (U_{C}) generated between the first and second electrode layers is within predetermined temperature dependent safe redox limits.

10. Apparatus according to claim 7, wherein the ammeter is further adapted to measure the current (i_{C}) flowing through the electrochromic cell over the time for calculating the charge inserted into the first and second electrode layers.

11. Apparatus according to claim 7, wherein the controller is further adapted to increase or decrease the applied voltage (U_{C}) depending on a measured voltage (U_{C}) of the first and second electrode layers.

12. Apparatus according to claim 7, wherein the controller is further adapted to determine a leakage current of the electrochromic cell.

13. Apparatus according to claim 7, wherein
the electrochromic material is present in the form of nanoobjects.

14. Apparatus according to claim 7, wherein
the electronically conductive nanoobjects are nanowires.

15. Apparatus according to claim 7, wherein
the first electrode layer is disposed on a first optically transparent electronically conductive layer, and the first contact member contacts the first optically transparent electronically conductive layer,
the second electrode layer is disposed on a second optically transparent electronically conductive layer, and the second contact member contacts the second optically transparent electronically conductive layer,
the first optically transparent electronically conductive layer is disposed on a first electrically insulating optically transparent substrate,
the second optically transparent electronically conductive layer is disposed on a second electrically insulating optically transparent substrate, and
the first electrically insulating optically transparent substrate and/or second electrically insulating optically transparent substrate is glass or organic polymer.

16. Apparatus according to claim 7, wherein
the first electrode layer is disposed on a first electrically insulating optically transparent substrate, and the first contact member contacts an edge of the first electrode layer,
the first electrically insulating optically transparent substrate is glass or organic polymer,
the second electrode layer is disposed on an optically transparent electronically conductive layer, and the second contact member contacts the optically transparent electronically conductive layer,
the optically transparent electronically conductive layer is disposed on a second electrically insulating optically transparent substrate, and
the second electrically insulating optically transparent substrate is glass or organic polymer.

17. Apparatus according to claim 7, wherein
the first electrode layer is disposed on an electrically insulating optically transparent substrate, and the first contact member contacts an edge of the first electrode layer,
the first electrically insulating optically transparent substrate is glass or organic polymer,
the second electrode layer comprises:
an organic polymer matrix and dispersed within the organic polymer matrix:
an electrochromic material,
electronically conductive nanoobjects, and
an electrolyte dissolved in a solvent,
wherein the second electrode layer is disposed on an electrically insulating optically transparent substrate, and the second contact member contacts an edge of the second electrode layer, and
the second electrically insulating optically transparent substrate is glass or organic polymer.

18. System for switching at least one electrochromic cell, the system comprising a master unit and at least one apparatus comprising an electrochromic cell and a controller according to claim 7, wherein the master unit is coupled to the at least one apparatus and is adapted to supply a trigger signal to the controller of the at least one apparatus, wherein the controller of the at least one apparatus is adapted to switch the electrochromic cell of the at least one apparatus in response the trigger signal.

19. System according to claim 18, wherein the controller of the at least one apparatus is further adapted to store at least one of the measured parameter of the at least one apparatus.

20. System according to claim 19, wherein the controller of the at least one apparatus is in bidirectional communication with the master unit.

21. System according to claim 20, wherein the master unit is adapted to monitor the stored parameter of the at least one apparatus and to generate the trigger signal depending on the monitored parameter.
